(19) United States
(12) Patent Application Publication
(10) Pub. No.: US 2006/0240884 A1
(43) Pub. Date: Oct. 26, 2006

(54) Ultrasonic sensor on a grain tank cover

(76) Inventor: Torsten Klimmer, Zweibrucken (DE)

Correspondence Address: DEERE & COMPANY, ONE JOHN DEERE PLACE, MOLINE, IL, 61265, US

(21) Appl. No.: 11/402,782

(22) Filed: Apr. 12, 2006

(30) Foreign Application Priority Data
Apr. 20, 2005 (DE) 10 2005 018 41.4

(51) Int. Cl. A01F 12/60

(52) U.S. Cl. 460/119

(57) ABSTRACT

The invention concerns a grain tank for a combine harvester with a grain tank cover which can move between a closed and an opened position, closing off the grain tank at the top in the closed position, and in the open position expanding the useful volume of the grain tank upward. A rangefinder is proposed for detecting the fill level in the grain tank, which is arranged such that it is in a position above the maximum fill level of the fill material suitable for detecting the fill level of the fill material when the grain tank cover is opened, while when the grain tank cover is closed it is covered by the latter.

### FIELD OF THE INVENTION

The invention concerns a grain tank for a combine harvester with a grain tank cover which can move between a closed and an opened position, closing off the grain tank at the top in the closed position, and in the open position expanding the useful volume of the grain tank upward.

### BACKGROUND OF THE INVENTION

Combine harvesters are machines which move across a field to harvest and thresh the grains planted there and to separate the kernel from the rest of the harvested material. The cleaned grain is kept for the time being in a grain tank, and when the tank is full enough the grain is transferred to a transport vehicle. The operator or the controls provided for this purpose require information as to the fill level of the grain tank, so that when the tank is full they can send the proper signals to have the transport vehicle come up to the combine harvester and take on the grain. Furthermore, the fill level of the grain tank can be used to measure or chart the yield.

U.S. Pat. No. 5,282,389 A and WO 00/35265 A each propose detecting the fill level of the grain tank of a combine harvester by means of an ultrasound sensor. Details as to the mounting of the ultrasound sensor have not been disclosed.

U.S. Pat. No. 5,957,773 A describes an experimental combine harvester in which the cleaned grain is taken to a test container. The fill level of the grain is detected by an ultrasound sensor rigidly arranged at the top end, approximately in the middle of the test container.

DE 100 51 096 A describes a combine harvester with a closable grain tank cover for enlarging the volume of the grain tank.

### SUMMARY OF THE INVENTION

The underlying problem of the invention is considered to be the provision of a suitable mounting for an ultrasound sensor in a grain tank in order to detect the fill level.

This problem is solved by the invention through the teaching of claim 1, while the additional patent claims present features which further develop the solution in an advantageous manner.

A grain tank for a self-propelled combine harvester has a grain tank cover which can move between a closed position and an opened position. A noncontact-type distance-measuring device serves to detect the fill level of the grain tank. It is coupled to the grain tank cover in such a way that it is covered on top by the grain tank cover and protected against the environment when the grain tank cover is in the closed position. If the grain tank cover is in the opened position, in which it enlarges the grain tank in the upward direction, the rangefinder finds itself in a position above the maximum fill level, so that it can even detect the fill level of the grain tank when not only the grain tank, but also the volume enlarged by the grain tank cover, is being used for filling purposes.

The rangefinder preferably works with electromagnetic waves, such as radio waves (radar) or light (laser), and it is possible to use interferometer techniques. As an alternative or in addition to this, acoustic waves such as ultrasound are beamed out by the rangefinder and waves reflected from the surface of the fill are received. The rangefinder uses the travel time and/or the intensity of the waves reflected by the fill to determine the distance between it and the surface of the fill. In the case of using acoustic waves for the distance measurement, the current ambient temperature can be detected and taken into account to improve the measurement accuracy. From the distance thus determined, a suitable computer device can deduce and display and/or save in memory the fill level (height of fill and/or volume of fill). Already known techniques (see DE 38 12 2893 C, whose disclosure is incorporated in the present documents by reference) can be used to diminish measurement errors due to moving fill material that is dumped from a filling device into the grain tank and reflects waves toward the rangefinder. It would also be conceivable to compensate for reflections by the geometry of the grain tank by using a suitable evaluation, possibly one dependent on the fill level.

Various possibilities exist for the arrangement of the rangefinder. In a first embodiment, a filling device (generally a filling screw) protruding into the grain tank can move between an extended position and a retracted position, and it supports the rangefinder. The filling device generally moves in synchronization with the grain tank cover, so that the filling device is in the retracted (extended) position when the grain tank cover is in the closed (opened) position. Preferably, the actuator used to move the filling device is also used to move the grain tank cover. But it is also conceivable to have separate actuators for the filling device and for the grain tank cover.

In another embodiment, the rangefinder is fastened on the grain tank cover and moves along with it between the closed and the opened positions, generally performing a pivoting motion in this process.

### BRIEF DESCRIPTION OF THE DRAWINGS

The drawings show three sample embodiments, described more closely hereinafter. They show:

FIG. 1, a schematic view of a combine harvester with a grain tank and a grain tank cover,

FIG. 2, an oblique view of the grain tank cover in its opened position,

FIG. 3, an oblique view of the grain tank cover in its closed position,

FIG. 4, a partial section of the grain tank and the opened grain tank cover with a first embodiment of a measuring device for detecting the fill level,

FIG. 5, the view from FIG. 4 with closed grain tank cover,

FIG. 6, a partial section of the grain tank and the opened grain tank cover with a second embodiment of a measuring device for detecting the fill level,

FIG. 7, the view from FIG. 6 with closed grain tank cover,

FIG. 8, a partial section of the grain tank and the opened grain tank cover with a third embodiment of a measuring device for detecting the fill level.

### DESCRIPTION OF THE PREFERRED EMBODIMENT

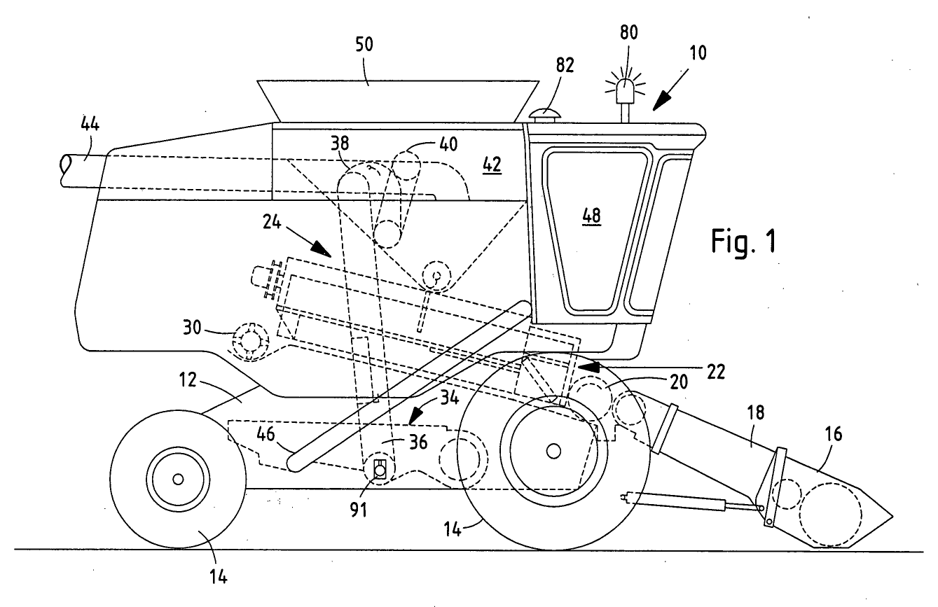

FIG. 1 shows a farming combine 10 with a chassis 12 and running wheels 14 extending from it. A crop-retrieval device 16 is used to scoop up the crops and feed them to an inclined conveyor 18. The crops are fed from the inclined conveyor 18 to a guide drum 20. The guide drum 20 takes the crops upward through an intake transition zone 22 to an axial separating device 24. Although the invention is described in connection with an axial-type combine harvester, it can also be used on other types of harvesters, such as conventional straw shaker combines or hybrid combines with a threshing drum connected to a rotor separating device. The directions indicated below, such as forward, backward, upward and downward, relative to the direction of forward movement of the combine 10.

The crops are threshed and separated in the axial separating device 24. In this process, grain is removed from the harvested crop mat and drops down, along with unthreshed ears of grain, chaff, and other harvest material, through the threshing basket and the grill arranged underneath the axial separating device 24, into a cleaning system 34. Larger harvesting residues are ejected through an exit drum 30 at the back of the axial separating device 24.

The cleaning system 34 is outfitted with a blower, which blows out chaff to the rear of the combine 10. The heavier clean grain is taken by a screw conveyor for clean grain, mounted transversely, to paddle elevator 36 for clean grain. The paddle elevator 36 takes the grain upward to a transitional housing 38, in which the grain is fed to a conveyor screw 40 for loading a grain tank 42 with clean grain. When a sufficient fill level is attained, the grain is removed from the grain tank 42 by an unloading screw conveyor 44. The operation of the combine 10 is controlled from an operator's cabin 48.

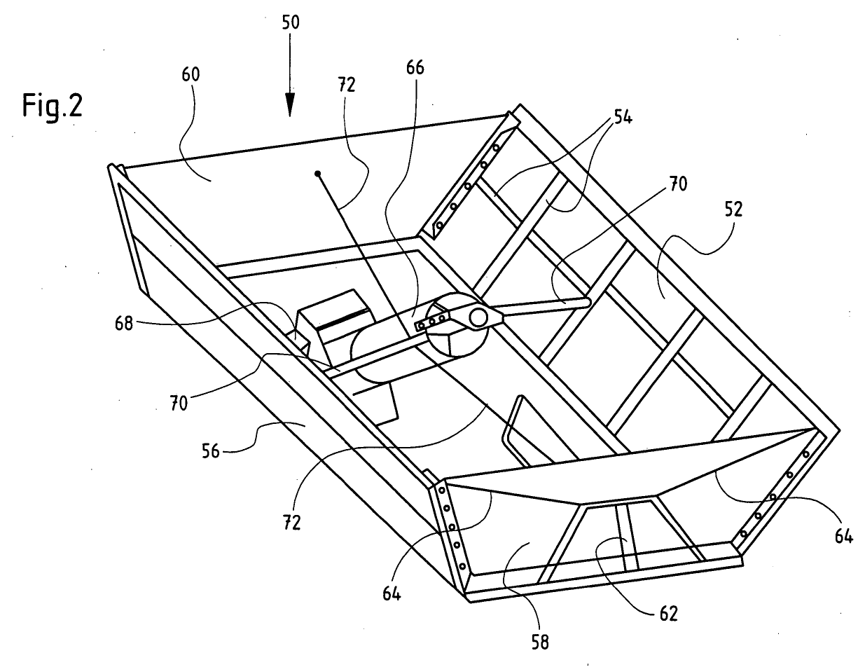

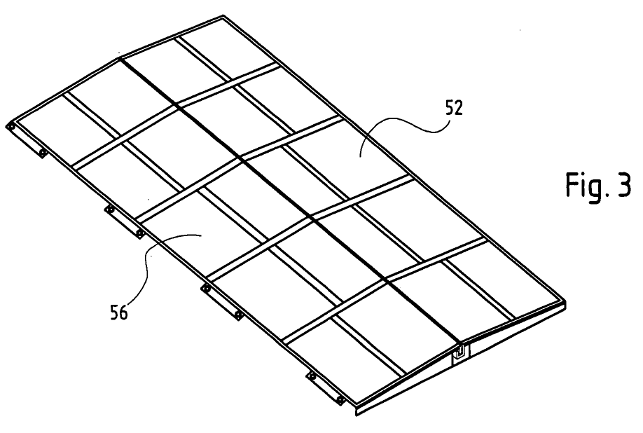

A grain tank cover 50 is arranged on top of the grain tank 42, which is open at the top. In FIGS. 1, 2, 4, 6 and 8 the grain tank cover 50 is shown in its opened position, i.e., its operating position, while in FIGS. 3, 5 and 7 it is in its closed position.

The grain tank cover 50 comprises a front wall 52 in the direction of forward travel of the combine 10, which is made from rigid material, from sheet metal with reinforced lengthwise and transverse ribs 54 in the embodiment depicted. The grain tank cover 50, furthermore, has a rear wall 56, which is identical to the front wall 52. On either side of the combine 10, the grain tank cover 50 is provided with side walls 58 and 60 of flexible material, e.g., rubberized fabric. The side walls 58, 60 are joined at their side edges to the front wall 52 and the rear wall 56 and at their lower edge to the wall of the grain tank 42. The front wall 52 and rear wall 56 are fastened to the walls of the grain tank 42 and can pivot at their lower ends about horizontal axes running transverse to the direction of travel of the combine 10. The front wall 52, rear wall 56 and side walls 58, 60 thus form a funnel-shaped, ring-like and upwardly open container in the operating position.

On the outer surfaces of the side walls 58, 60 of flexible material is arranged a support element 62 in the form of a downwardly open arch with a central, vertical strut (the support element associated with the left side wall 60 is not visible in FIG. 2). The support elements 62 are joined by cable 64 lying against the outer surfaces of the side walls 58, 60 to the upper corners of the front wall 52 and the rear wall 56. The support elements 62 are hinged at their lower ends to the wall of the grain tank 42 so they can pivot about horizontal axes running parallel to the direction of travel of the combine 10. They can swivel upward in order to buttress the side walls 58, 60, but only through a maximum of 90 degrees, and no further.

A grain tank filling device in the form of a filling pipe 66, containing the conveying screw 40, is arranged inside the grain tank 42 and transports the threshed material from the cleaning system 34 to the grain tank 42. The filling pipe 66 can swivel by a drive mechanism 68, comprising a hydraulic or electric motor, between an extended position as shown in FIG. 2, in which the filling pipe 66 extends upward at an angle of around 45 degrees, and a retracted position, in which the filling pipe 66 is dropped down into the interior of the grain tank 42 and only extends upward by about 20 degrees. In the extended position, the outlet opening at the upper end of the filling pipe 66 is arranged inside the ring formed by the side walls 52, 56, 58, and 60 of the grain tank cover 50. Thus, the grain tank cover 50 can be filled up to the top edge with grain.

The filling pipe 66 is joined to each of the front wall 52 and rear wall 56 by a connecting rod element 70, which transmits pushing and pulling forces. The connection element 70 is linked by suitable hinges to the filling pipe 66 and to each wall 52, 56. When the filling pipe 66 is moved by the drive mechanism 68 from the extended position as shown in FIG. 2 to the retracted position, the connection elements 70 make sure that the front wall 52 and the rear wall 56 pivot toward the inside of the grain tank 42. Due to the cables 64 joined to the front wall 52 and rear wall 56 now being slack, the support elements 62 are folded inward, assisted by cables 72 stretched between each side wall 58, 60 and the filling pipe 66. In this way, the side walls 58, 60 are folded inward. The cables 72 are joined to the support elements 62 and brace them and the side walls 58, 60 in the operating position, which is of special benefit when the grain tank cover 50 is full.

As shown by FIG. 3, the front wall 52 and the rear wall 56 in the closed position form a closed lid for the grain tank 42, protecting it and the side walls 58, 60 from environmental influences.

The grain tank cover 50 is placed in the extended position in similar manner. The filling pipe 66 is lifted by the drive mechanism 68, so that the connection elements 70 swing the front wall 52 and the rear wall 56 up by about 120 degrees, until the cables 64 are taut. Thanks to the stretched cables 64, the support elements 62 are pivoted outward by about 90 degrees into the operating position. The cables 64 also restrict the pivot travel of the support elements 62. The side walls 58, 60 are joined by suitable fastening means to the support elements 62, so that they also go into the operating position.

It should be noted that the grain tank cover 50 could also be rotated 90 degrees relative to the embodiment depicted, i.e., with the flexible side walls 58, 60 extending across the direction of travel. Nor do the side walls 58, 60 need to be made of flexible material, but instead could be made of rigid material, such as sheet metal (see DE 40 16 319 C, DE 44 45 933 A).

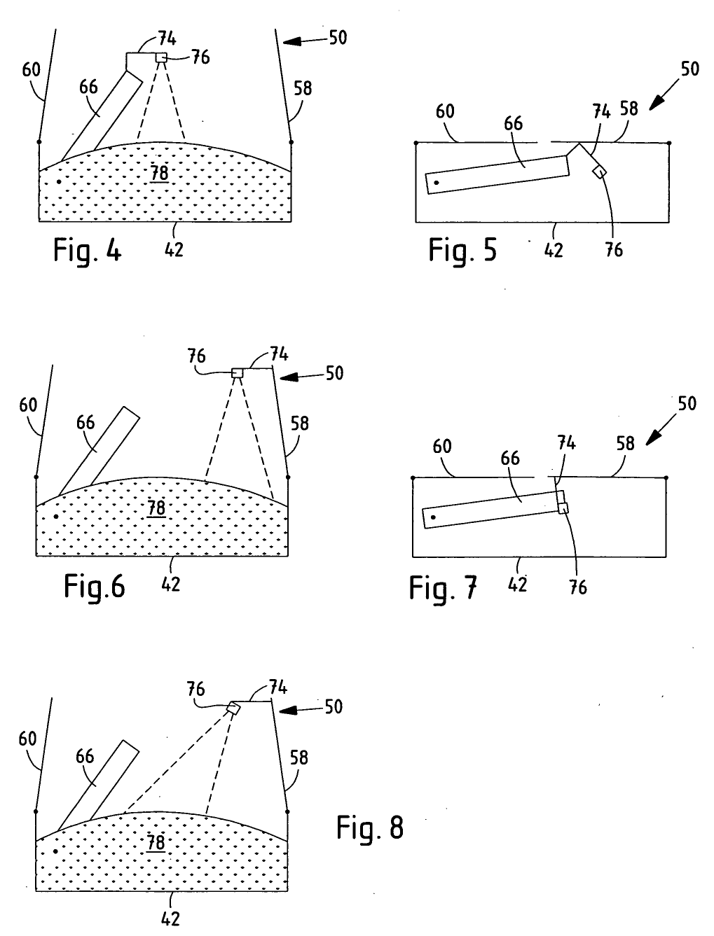

FIG. 4 shows the grain tank 42 and the opened grain tank cover 50 in a partial cross section, viewed from behind. At the top end of the filling pipe 66 is fastened a rigid support 74 which rigidly supports a rangefinder 76. When in operation, the rangefinder 76 beams ultrasonic waves onto the surface of the material (grain) contained in the grain tank 42 and in the grain tank cover 50 and receives the waves reflected from the surface. By using the travel time and/or intensity of the reflected waves, a computer device (not shown) determines the fill level of the grain tank 42 and indicates this optically or acoustically to the operator in the cabin 48 via an output device. To transmit the data concerning the fill level to a display device in the cabin 48, one can use a data transmission bus (CAN). In addition, or as an alternative, it would also be conceivable to send a signal to the operator when reaching a predetermined fill level, to be used to actuate a signal light 80 and/or transmit wirelessly to a transport vehicle. The fill level or a quantity derived from it, such as the fill volume or (if the density of the harvested crop is known) the mass of the harvest material can also be georeferenced and saved in memory for purposes of precision agriculture, for which a satellite antenna 82 should be provided to receive signals from a global positioning system.

When the filling pipe 66 is placed in the retracted position, as shown in FIG. 5, the support 74 with the rangefinder 76 also goes inside the grain tank 42, where it is protected by the walls 52, 56, 68 and 60 of the grain tank lid 50, which are brought into the closed position along with the filling pipe 66.

A second embodiment of the mounting of the rangefinder 76 is depicted in FIGS. 6 and 7, where the support 74 is joined rigidly to the wall 58, preferably to the top of the support element 62. The support 74 could also be joined to one of the rigid walls 52 or 56. The rangefinder 76 interacts with the forward region of the pile of grain 78, and when the grain tank cover 50 is in the closed position it lies in front of or behind the filling pipe 66 in the direction of travel.

The embodiment of FIG. 8 differs from that shown in FIGS. 6 and 7 merely in that the rangefinder 76 interacts with the center of the pile of grain 78. In this embodiment, the actual height of fill can be found by triangulation.

Having described the preferred embodiment, it will become apparent that various modifications can be made without departing from the scope of the invention as defined in the accompanying claims.

1. A grain tank for a combine harvester with a grain tank cover which can move between a closed and an opened position, closing off the grain tank at the top in the closed position, and in the open position expanding the useful volume of the grain tank upward, characterized by a rangefinder for detecting the fill level in the grain tank which is arranged such that it is in a position above the maximum fill level of the fill material suitable for detecting the fill level of the fill material when the grain tank cover is opened, while when the grain tank cover is closed it is covered by the latter.

2. The grain tank according to claim 1, wherein the rangefinder is designed to beam electromagnetic waves, especially optical ones, and/or acoustic waves onto the surface of the material contained in the grain tank, to detect waves reflected from the surface of the fill material, and to use the received waves to determine its distance from the surface or the fill level of the material.

3. The grain tank according to claim 1, wherein the rangefinder is fastened to the grain tank cover.

4. The grain tank according to claim 1, wherein the rangefinder is fastened to a grain tank filling device, which can move between an extended position and a retracted position.

5. The grain tank according to claim 2, wherein the rangefinder is fastened to the grain tank cover.

6. The grain tank according to claim 2, wherein the rangefinder is fastened to a grain tank filling device, which can move between an extended position and a retracted position.
